(19) United States
(12) Patent Application Publication
(10) Pub. No.: US 2009/0268818 A1
(43) Pub. Date: Oct. 29, 2009

(54) METHOD AND SYSTEM FOR INTEGRATING NOISE FILTERING IN PREDICTIVE VIDEO CODING

(75) Inventors: Ligang Lu, New City, NY (US); Vadim Sheinin, Yorktown Heights, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/111,677

(22) Filed: Apr. 29, 2008

(51) Int. Cl. H04N 7/32; H04N 7/26

(52) U.S. Cl. 375/240.15; 375/240.12; 375/E07.246

(57) ABSTRACT

A method and system are disclosed for coding and filtering video data. The method comprises the steps of using a predictive coding technique to compress a stream of video data, integrating a noise filtering process into said predictive coding technique, and using said noise filtering process to noise filter said stream of video data while compressing said stream of video data. In the preferred embodiment of the invention, the stream of video data is comprised of a series of macroblocks, including a current macroblock and at least one reference macroblock. Also, in this preferred embodiment, the step of using a predictive coding technique includes the step of calculating the difference between the current macroblock and the at least one reference macroblock, and the step of integrating the noise filtering process includes the step of integrating the noise filtering process into said step of calculating. The invention may be used with a forward predictive code mode and with a bi-directional predictive mode.

### BACKGROUND OF THE INVENTION

1. Field of the Invention

The present invention generally relates to video compression, and more specifically, to reducing noise in a video stream during compression.

2. Background Art

In order to achieve real time, high fidelity video transmission, state of the art video transmission systems typically employ both data compression and noise filtering. The goal of digital video compression is to represent an image with as low a bit rate as possible, while preserving an appropriate level of picture quality for a given application. Compression is achieved by identifying and removing redundancies.

A bit rate reduction system operates by removing redundant information from the signal at the encoder prior to transmission and re-inserting that redundant information at the decoder. An encoder and decoder pair are referred to as a ‘codec’. In video signals, two distinct kinds of redundancy can be identified: (i) spatial and temporal redundancy, and (ii) psycho-visual redundancy.

Spatial and temporal redundancy occurs when pixel values are not independent, but are correlated with their neighbors both within the same frame and across frames. To some extent, the value of a pixel is predictable given the values of neighboring pixels.

Psycho-visual redundancy is based on the fact that the human eye has a limited response to fine spatial detail and is less sensitive to detail near object edges or around shot-changes. Consequently, controlled impairments introduced into the decoded picture by the bit rate reduction process are not visible to a human observer.

At its most basic level, compression is performed when an input video stream is analyzed and information that is indiscernible to the viewer is discarded. Each event is then assigned a code where commonly occurring events are assigned fewer bits and rare events are assigned more bits. These steps are commonly referred to as signal analysis, quantization and variable length encoding. Common methods used in compression include discrete cosine transform (DCT), discrete wavelet transform (DWT), Differential Pulse Code Modulation (DPCM), vector quantization (VQ) or scalar quantization, and. entropy coding.

The most common video coding method is described in the MPEG and H.26X standards. The video data undergo four main processes before transmission, namely prediction, transformation, quantization and entropy coding.

The prediction process significantly reduces the amount of bits required for each picture in a video sequence to be transferred. It takes advantage of the similarity of parts of the sequence with other parts of the sequence. Since the predictor part is known to both encoder and decoder, only the difference has to be transferred. This difference typically requires much less capacity for its representation. The prediction is mainly based on picture content from previously reconstructed pictures where the location of the content is defined by motion vectors. The prediction process is typically performed on square block sizes (e.g., 16×16 pixels). In some cases however, predictions of pixels based on the adjacent pixels in the same picture rather than pixels of preceding pictures are used. This is referred to as intra prediction, as opposed to inter prediction.

The residual, represented as a block of data (e.g., 4×4 pixels), still contains spatial correlation among its elements. A well-known method of taking advantage of this is to perform a two-dimensional block transform to represent the data in a different domain to facilitate operations for more efficient compression. The ITU recommendation H.264 uses a 4×4 integer type transform. This transforms 4×4 pixels into 4×4 transform coefficients and fewer bits than the pixel representation can usually represent them. Transform of a 4×4 array of pixels with spatial correlation will probably result in a 4×4 block of transform coefficients with much fewer non-zero values than the original 4×4 pixel block.

Direct representation of the transform coefficients is still too costly for many applications. A quantization process is carried out for a further reduction of the data representation. Hence the transform coefficients undergo quantization. The possible value range of the transform coefficients is divided into value intervals each limited by an uppermost and lowennost decision threshold and assigned a fixed quantization value (or index). The transform coefficients are then quantified to the quantization values associated with the intervals within which the respective coefficients reside. Coefficients being lower than the lowest decision value are quantified to zeros.

Video sources are usually contaminated with noises. For example, under low lighting conditions, video sources captured with cameras or sensors will contain significant amount of random noises. If the noise is not removed from the video source before compression, the coding efficiency will be significantly reduced. This problem becomes more serious in low bit rate and low complexity video coding applications, such as video surveillance and wireless video communication, since precious coding bits and encoder computation cycles are wasted in coding the noises.

Thus, in most video compression systems, various filtering techniques are used for noise reduction in video encoding. Noise reduction and filtering can substantially improve the video quality received by the viewer if the right techniques are applied to remove noise. Noise removal is a challenge because noise usually shares some part of the signal spectrum as the original video source. An ideal noise reduction process will allow powerful suppression of random noise while preserving original video content. Good noise reduction means applying filters that preserve details such as edge structure in an image while avoiding blurring, trailing or other effects adverse to the fidelity of the image. Most filtering algorithms such as Motion Compensated Temporal Filtering (MCTF) add a heavy pre-filtering computational load on the encoder.

The prior art noise filtering techniques in video compression systems use stand-alone filtering processes, i.e., the noise filtering process is considered and performed as a separate operation in these video coding methods and systems. Therefore, such prior noise filtering techniques incur a significant amount of additional computation cost to the encoder. In low complexity and low bit rate video coding applications, both coding bits and computation cycles are very limited; it is not desirable to employ a stand-alone filtering approach and new solutions are needed.

### SUMMARY OF THE INVENTION

An object of the present invention is to improve noise filtering in predictive video encoding.

Another object of this invention is to achieve temporal noise filtering with a prediction error computation operation in a predictive video coding system, with no significant additional cost in computation cycles.

A further object of the invention is to integrate a temporal noise filtering process with an existing prediction error computation operation in a predictive video coding system without any significant additional cost in computation cycles.

These and other objectives are attained with a method and system for coding and filtering video data. The method comprises the steps of using a predictive coding technique to compress a stream of video data, integrating a noise filtering process into said predictive coding technique, and using said noise filtering process to noise filter said stream of video data while compressing said stream of video data.

In the preferred embodiment of the invention, the stream of video data is comprised of a series of macroblocks, including a current macroblock and at least one reference macroblock. Also, in this preferred embodiment, the step of using a predictive coding technique includes the step of calculating the difference between the current macroblock and the at least one reference macroblock, and the step of integrating the noise filtering process includes the step of integrating the noise filtering process into said step of calculating.

In one embodiment, the predictive coding technique is a forward predictive code mode. In this embodiment, the step of using the predictive coding technique includes the step of identifying a block as the best predictor of said current macroblock, and identifying a prediction error between said best predictor and said current macroblock. In addition, in this embodiment, the step of integrating the noise filtering into the predictive coding technique includes the step of scaling said predictor error to obtain a scaled predictor error, and the step of using the noise filtering process includes the step of using this scaled prediction error to noise filter the video stream.

In a second embodiment, the predictive coding technique is a bi-directional predictive code mode. In this embodiment, the step of using the predictive coding technique includes the step of identifying one previous macroblock and one future macroblock as the two best predictors of said current macroblock, and identifying a prediction error between said two best predictors and said current macroblock. Also, in this embodiment, the step of integrating the noise filtering into the predictive coding technique includes the step of scaling this prediction error to obtain a scaled prediction error, and the step of using the noise filtering process includes the step of using this scaled prediction error to noise filter the video stream.

The preferred embodiment of the invention, described below in detail, integrates the temporal noise filtering process with the existing prediction error computation operation in predictive video coding system, and, consequently, no significant cost in computation cycles in addition to the prediction error calculation is needed.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 illustrates an MPEG-2 video sequence.

FIG. 2 is a block diagram of an example MPEG-2 encoder.

FIG. 3 is a block diagram of an example MPEG-2 decoder.

FIG. 4 illustrates the integration of temporal noise filtering process with an existing prediction error computation operation in accordance with a preferred embodiment of the present invention.

FIG. 5 is a block diagram of an exemplary computing environment in which the invention may be implemented.

### DETAILED DESCRIPTION OF THE PREFERRED EMBODIMENTS

The present invention will be described in terms of an embodiment applicable to the reduction of noise content by integrating noise filtering in predictive video coding. It will be understood that the essential concepts disclosed herein are applicable to a wide range of compression standards, codecs, electronic systems, architectures and hardware elements.

Video compression techniques can be broadly categorized as lossless and lossy compression techniques. Most video compression techniques use a combination of lossless and lossy techniques to reduce the bit rate. These techniques can be used separately or they can be combined to design very efficient data reduction systems for video compression. Lossless data compression is a class of data compression algorithms that allow the original data to be reconstructed exactly from the compressed data. A lossy data compression method is one where compressing a file and then decompressing it produces a file that may be different from the original, but has sufficient information for its intended use. In addition to compression of video streams, lossy compression is used frequently on the Internet and especially in streaming media and telephony applications.

Image and video compression standards have been developed to facilitate easier transmission and/or storage of digital media and allow the digital media to be ported to discrete systems. Some of the most common compression standards include, but are not limited to, JPEG, MPEG-1, MPEG-2, MPEG-4, H.261, H.263, H.264, DV, and DivX.

JPEG stands for Joint Photographic Experts Group. JPEG is a lossy compression technique used for full-color or gray-scale images, by exploiting the fact that the human eye will not notice small color changes. JPEG, like all compression algorithms, involves eliminating redundant data. JPEG, while designed for still images, is often applied to moving images, or video. JPEG 2000 provides an image coding system using compression techniques based on the use of wavelet technology.

MPEG (Moving Picture Experts Group) specifications and H.26x recommendations are the most common video compression standards. These video coding standards employ motion estimation, motion compensated prediction, transform coding, and entropy coding to effectively remove both the temporal and spatial redundancy from the video frames to achieve a significant reduction in the bits required to describe the video signal. Consequently, compression ratios above 100:1 with good picture quality are common.

A video encoder may make a prediction about an image (a video frame) and transform and encode the difference between the prediction and the image. The prediction accounts for movement between the image and its prediction reference image(s) by using motion estimation. Because a given image's prediction may be based on future images as well as past ones, the encoder must ensure that the reference images are encoded and transmitted to the decoder before the predicted ones. Therefore sometimes, the encoder needs to reorder the video frames according to their coding order. The decoder will put the images back into the original display sequence. It takes about 1.1-1.5 billion operations per second for real-time MPEG-2 encoding.

So far, several digital video coding standards have been developed. Each compression standard was designed with a specific application and bit rate in mind, although MPEG compression scales well with increased bit rates. The different MPEG standards are described below:

a. MPEG-1 was developed for a 1.5 Mbit/sec standard for the compression of moving pictures and audio for storage applications.

b. MPEG-2 is designed for a 1.5 to 15 Mbit/sec standard for Digital Television Broadcast and DVD applications. The process of MPEG-2 coding will be described in detail below with reference to an embodiment of the invention.

c. MPEG-4 is a standard for multimedia and Internet compression.

DV or Digital Video is a high-resolution digital video format used with video cameras and camcorders.

H.261 is a standard designed for two-way communication over ISDN lines (for video conferencing) and supports data rates that are multiples of 64 Kbit/s.

H.263 is based on H.261 with enhancements that improve video quality over modems.

H.264 is the latest and the state of the art of the digital video coding standard. It has the best compression performance; however, this is achieved at the expense of the higher encoder complexity.

DivX is a software application that uses the MPEG-4 standard to compress digital video, so it can be downloaded over the Internet with no reduced visual quality.

The MPEG-2 motion picture coding standard uses a combination of lossless and lossy compression techniques to reduce the bit rate of a video stream. MPEG-2 is an extension of the MPEG-1 international standard for digital compression of audio and video signals. The most significant enhancement from MPEG-1 is its ability to efficiently compress interlaced video. MPEG-2 scales well to HDTV resolution and bit rates. MPEG-2 provides algorithmic tools for efficiently coding interlaced video, supports a wide range of bit rates and provides for multi-channel surround sound coding.

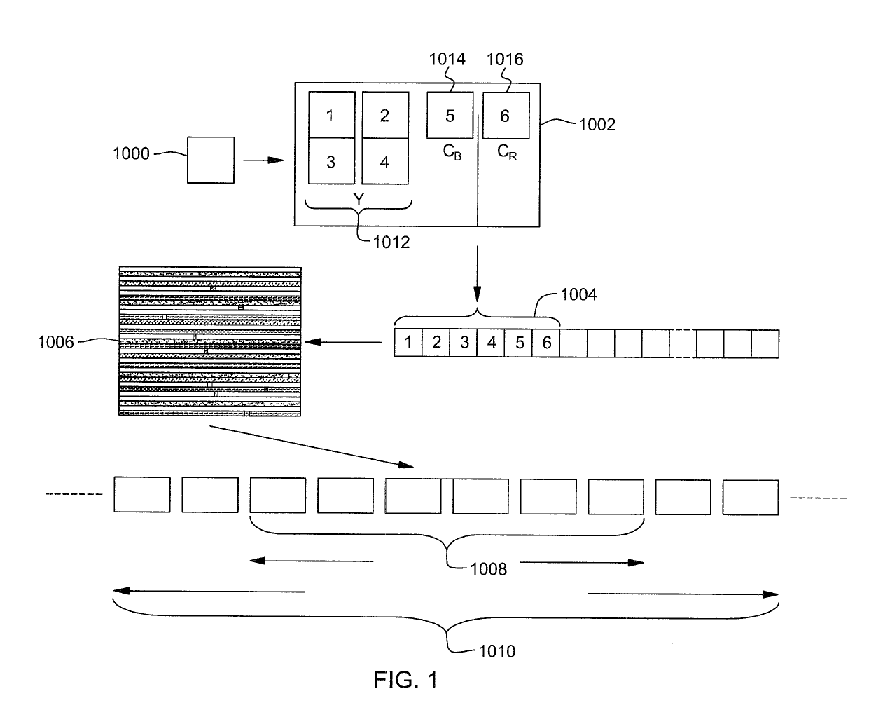

FIG. 1 illustrates the composition of a 4:2:0 MPEG-2 video sequence 1010. The MPEG-2 data structure is made up of six hierarchical layers. These layers are the block 1000, macroblock 1002, slice 1004, picture 1006, group of pictures (GOP) 1008 and the video sequence 1010.

Luminance and chrominance data of an image in the 4:2:0 format of a MPEG-2 video stream are separated into macroblocks that each consist of four luma (Y) blocks 1012 of 8×8 pixel values in a window of 16×16 pixels of the original picture and their associated color difference blue chroma (C_{B}) block 1014 and red chroma (C_{R}) block 1016. The number of chroma blocks in the macroblock depends on the sampling structure (e.g., 4:4:4, 4:2:2 or 4:2:0). Profile information in the sequence header selects one of the three-chroma formats. In the 4:2:0 format as shown in FIG. 1, a macroblock consists of 4 Y blocks 1012, 1 C_{B} block 1014 and 1 C_{R} block 1016. In the 4:2:2 format a macroblock consists of 4 Y blocks, 2 C_{R} blocks and 2 C_{B} blocks. In the 4:4:4 format a macroblock consists of 4 Y blocks, 4 C_{R} blocks and 4 C_{B} blocks.

The slice 1004 is made up of a number of contiguous macroblocks. The order of macroblocks within a slice 1004 is the same as that in a conventional television scan: from left to right and from top to bottom. The picture, image or frame 1006 is the primary coding unit in the video sequence 1010. The image 1006 consists of a group of slices 1004 that constitute the actual picture area. The image 1006 also contains information needed by the decoder such as the type of image (I, P or B) and the transmission order. Header values indicating the position of the macroblock 1002 within the image 1006 may be used to code each block. There are three image, picture or frame 1006 types in the MPEG-2 codec:

a. Intra pictures (I-pictures) are coded without reference to other pictures. Moderate compression is achieved by reducing spatial redundancy, but not temporal redundancy. They can be used periodically to provide access points in the bit stream where decoding can begin.

b. Predictive pictures (P-pictures) can use the previous I or P-picture for motion compensated prediction and may be used as a reference for subsequent pictures. Each block in a P-picture can either be predicted or intra-coded. Only the prediction error of the block and its associated motion vectors will be coded and transmitted to the decoder. By exploiting spatial and temporal redundancy, P-pictures offer increased compression compared to I-pictures.

c. ‘Bidirectionally-predictive’ pictures (B-pictures) can use the previous and next I or P-pictures for motion-compensated prediction, and offer the highest degree of compression. Each block in a B-picture can be forward, backward or bidirectionally predicted or intra-coded. To enable backward prediction from a future frame, the coder reorders the pictures from their natural display order to an encoding order so that the B-picture is transmitted after the previous and next pictures it references. This introduces a reordering delay dependent on the number of consecutive B-pictures.

The GOP 1008 is made up of a sequence of various combinations of I, P and B pictures. It usually starts with an I picture which provides the reference for following P and B pictures and provides the entry point for switching and tape editing. GOPs 1008 typically contain 15 pictures, after which a new I picture starts a new GOP of P and B pictures. Pictures are coded and decoded in a different order than they are displayed. This is due to the use of bidirectional prediction for B pictures.

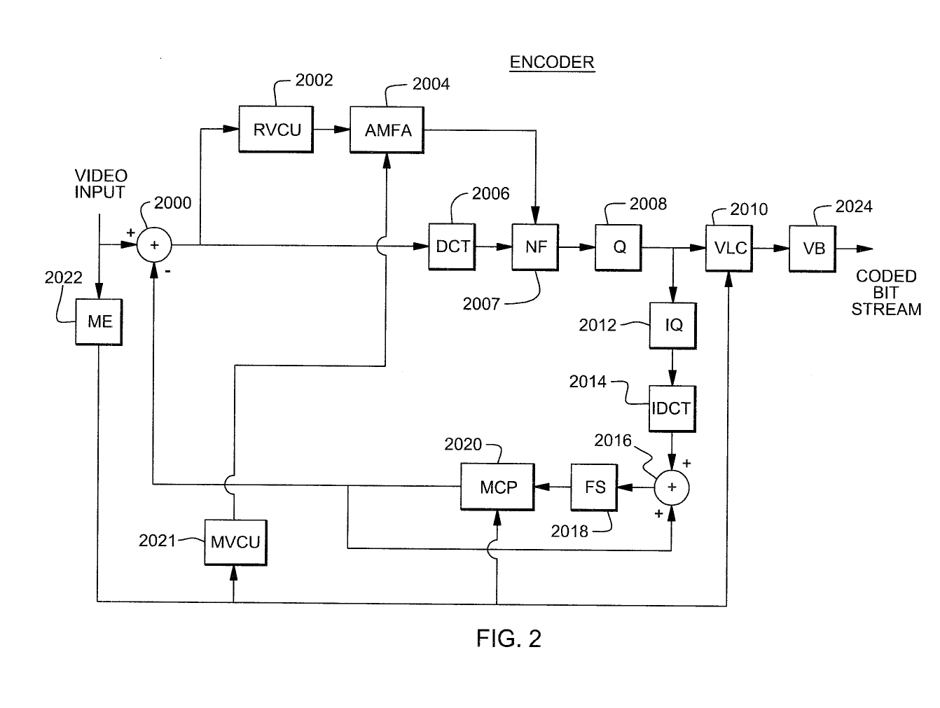

FIG. 2 is a block diagram of an example prior art MPEG-2 encoder with noise detection, classification and reduction elements. The example MPEG-2 encoder includes a subtractor 2000, a residual variance computation unit (RVCU) 2002, an adaptive motion filter analyzer (AMFA) 2004, a DCT unit 2006, a noise filter 2007, a quantizer unit 2008, a variable length coder (VLC) 2010, an inverse quantizer unit 2012, an inverse DCT unit 2014, an adder 2016, a frame storage unit 2018, a motion compensation predictor 2020, a motion vector correlation unit (MVCU) 2021, a motion estimator 2022 and a video buffer 2024.

Typically, the function of an encoder is to transmit a discrete cosine transformed macroblock from the DCT unit 2006 to the decoder, in a bit rate efficient manner, so that the decoder can perform the inverse transform to reconstruct the image. The numerical precision of the DCT coefficients may be reduced while still maintaining good image quality at the decoder. This is done by the quantizer 2008. The quantizer 2008 is used to reduce the number of possible values to be transmitted thereby reducing the required number of bits. The ‘quantizer level’, ‘quantization level’ or ‘degree of quantization’ determines the number of bits assigned to a DCT coefficient of a macroblock. The quantization level applied to each coefficient is weighted according to the visibility of the resulting quantization noise to a human observer. This results in the high-frequency coefficients being more coarsely quantized than the low-frequency coefficients. The quantization noise introduced by the encoder is not reversible in the decoder, making the coding and decoding process lossy.

Macroblocks of an image to be encoded are fed to both the subtractor 2000 and the motion estimator 2022. The motion estimator 2022 compares each of these new macroblocks with macroblocks in a previously stored reference picture or pictures. The motion estimator 2022 finds a macroblock in a reference picture that most closely matches the current macroblock. The motion estimator 2022 then calculates a ‘motion vector’, which represents the horizontal and vertical displacement from the macroblock being encoded to the matching macroblock-sized area in the reference picture. An ‘x motion vector’ estimates the horizontal displacement and a ‘y motion vector’ estimates the vertical displacement. The motion estimator also reads this matching macroblock (known as a ‘predicted macroblock’) out of a reference picture memory and sends it to the subtractor 2000, which subtracts it, on a pixel-by-pixel basis, from the current macroblock entering the encoder. This forms a ‘prediction error’ or ‘residual signal’ that represents the difference between the predicted macroblock and the current macroblock being encoded. Prediction error is the difference between the information being coded and a predicted reference or the difference between a current block of pixels and a motion compensated block from a preceding or following decoded picture.

The MVCU 2021 is used to compute the correlation between motion vectors of the current macroblock and at least one reference macroblock and the relative size of motion vectors of the current macroblock. The variance of the residual signal is computed using the RVCU 2002. The correlation data and relative motion vector size from MVCU 2021 and the variance data from RVCU 2002 is fed into the AMFA 2004. Using the data from the RVCU 2002 and the MVCU 2021, the AMFA 2004 distinguishes noise from data, classifies the current macroblock according to the level of noise and selectively tags it for the appropriate level of filtering. The residual signal is transformed from the spatial domain by the DCT unit 2006 to produce DCT coefficients. The DCT coefficients of the residual are then filtered by noise filter 2007 using a filter strength specified by the AMFA 2004. The quantizer unit 2008 that reduces the number of bits needed to represent each coefficient then quantizes the filtered coefficients of the residual from noise filter 2007.

The quantized DCT coefficients from the quantizer unit 2008 are coded by the VLC 2010, which further reduces the average number of bits per coefficient. The result from the VLC 2010 is combined with motion vector data and side information (including an indication of whether it's an I, P or B picture) and buffered in video buffer 2024. Side information is used to specify coding parameters and is therefore sent in smaller quantities than the main prediction error signal. Variations in coding methods may include trade-offs between the amount of this side information and the amount needed for the prediction error signal. For example, the use of three types of encoded pictures in MPEG-2 allows a certain reduction in the amount of prediction error information, but this must be supplemented by side information identifying the type of each picture.

For the case of P pictures, the quantized DCT coefficients also go through an internal loop that represents the operation of the decoder (a decoder within the encoder). The residual is inverse quantized by the inverse quantizer unit 2012 and inverse DCT transformed by the inverse DCT unit 2014. The predicted macroblock read out of the frame storage unit 2018 (which acts as a reference picture memory) is processed by the motion compensation predictor 2020 and added back to the residual obtained from the inverse DCT unit 2014 by adder 2016 on a pixel by pixel basis and stored back into frame storage unit 2018 to serve as a reference for predicting subsequent pictures. The object is to have the reference picture data in the frame storage unit 2018 of the encoder match the reference picture memory data in the frame storage unit 3010 of the decoder. B pictures are not stored as reference pictures.

The encoding of I pictures uses the same circuit, however no motion estimation occurs and the negative input to the subtractor 2000 is forced to 0. In this case, the quantized DCT coefficients represent transformed pixel values rather than residual values, as was the case for P and B pictures. As is the case for P pictures, decoded I pictures are stored as reference pictures in the frame storage unit 2018.

For many applications, the bit stream from the VLC 2010 must be carried in a fixed bit rate channel. In these cases, the video buffer 2024 is placed between the VLC 2010 and the channel. The video buffer 2024 is filled at a variable rate by the VLC 2010 and produces a coded bit stream at a constant rate as its output.

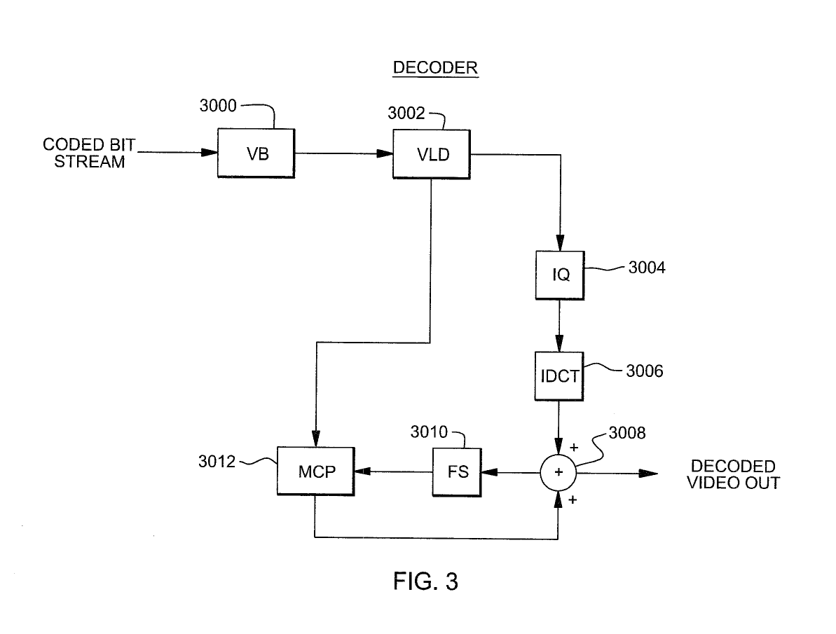

FIG. 3 is a block diagram of an example MPEG-2 decoder. The decoder includes a video buffer 3000, a variable length decoder (VLD) 3002, an inverse quantizer unit 3004, an inverse DCT unit 3006, an adder 3008, a frame storage unit 3010 and a motion compensation unit 3012.

The decoding process is the reverse of the encoding process. The coded bit stream received by the decoder is buffered by the video buffer 3000 and variable length decoded by the VLD 3002. Motion vectors are parsed from the data stream and fed to the motion compensation unit 3012. Quantized DCT coefficients are fed to the inverse quantizer unit 3004 and then to the inverse DCT unit 3006 that transforms them back to the spatial domain. For P and B pictures, motion vector data is translated to a memory address by the motion compensation unit 3012 to read a particular macroblock (a predicted macroblock) out of a reference picture previously stored in frame storage unit 3010. The adder 3008 adds this prediction to the residual to form reconstructed picture data. For I pictures, there are no motion vectors and no reference pictures, so the prediction is forced to zero. For I and P pictures, the adder 3008 output is fed back to be stored as a reference picture in the frame storage unit 3010 for future predictions.

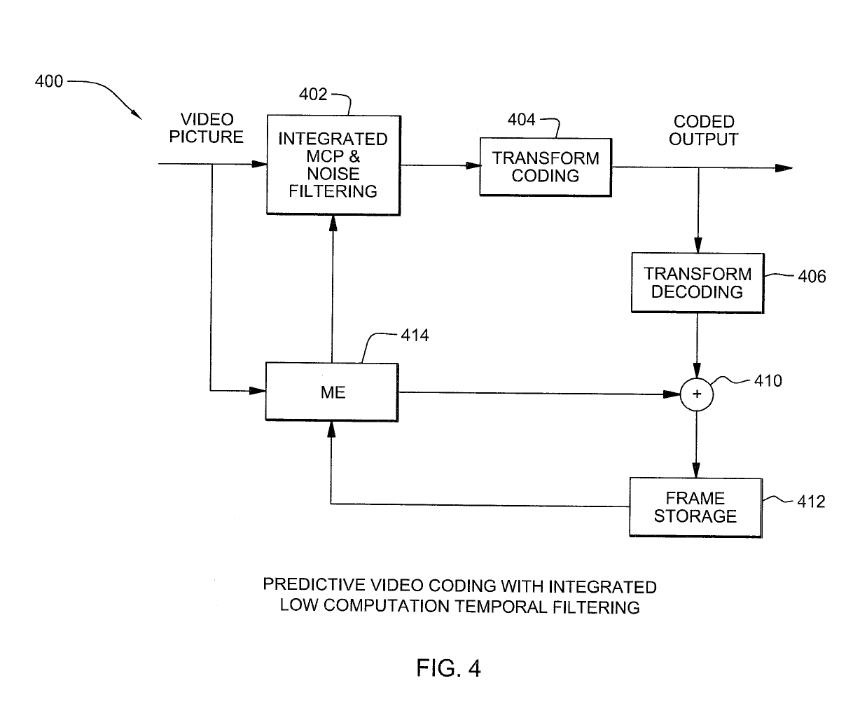

In predictive video coding (e.g., MPEG and H.264), motion compensated prediction (MCP) is used. The prediction error is formed by calculating the difference between the current block and the reference block(s). In accordance with this invention, the computations of the noise filtering process are integrated with the computations of the prediction process to create a new process, which requires no significant amount of additional computations to the prediction process. FIG. 4 illustrates an encoding process in which this integration occurs. In particular, FIG. 4 shows an Integrated MCP and noise filtering unit 402, a transform coding unit 404, a transform decoding unit 406, an adder 410, a frame storage 412, and a motion estimation (ME) unit 414.

### Exemplary Embodiments

In MPEG/H.264 most pictures are coded using forward prediction coding mode (e.g., P pictures) or bi-directional prediction coding mode (e.g., B pictures). To encode a pixel block A in the current picture using forward prediction coding mode, motion estimation is first performed to find the best predictor, a block Bₚ in the reference picture (a previous picture) that minimizes the difference criterion. Then, the motion compensated prediction error between A and Bₚ is calculated over the dimensions of the block by

E=A−Bₚ

Let A′ be a temporal filtered version of A. One example is to use a two-tap filter with filter coefficients (α, 1−α) such that A′=αA+(1−α) Bₚ. Then the prediction error is:

$$\begin{matrix}{E}^{′} = {A}^{′} - {B}_{p} \\ = α A + ( 1 - α ) {B}_{p} - {B}_{p} \\ = α E .\end{matrix}$$

Note that the temporal noise filtering can be achieved by a simple scaling of the prediction error; in particular, when α=0.5, the filter becomes a bi-linear filter and the operation of the temporal noise filtering can be completed by only one binary shift to the prediction error. The filter parameter α can be used to adaptively control the filtering strength and can be determined by the noise level or noise power.

Similarly, to encode a pixel block A in the current picture using bi-directional prediction mode, motion estimation is performed on two reference pictures, one previous picture and one future picture, to find two corresponding best predictors, say B₁ and B₂, respectively. The motion compensated bi-directional prediction error is given by:

$$\begin{matrix}{E}^{′} = {A}^{′} - ( {B}_{1} + {B}_{2} ) / 2 \\ = α A + ( 1 - α ) ( {B}_{1} + {B}_{2} ) / 2 - ( {B}_{1} + {B}_{2} ) / 2 \\ = α [ A - ( {B}_{1} + {B}_{2} ) / 2 ] . \\ = α E .\end{matrix}$$

In this case, the operation of the temporal noise filtering can also be completed by only one scaling and when α=0.5 with only one binary shift to the bi-directional prediction error.

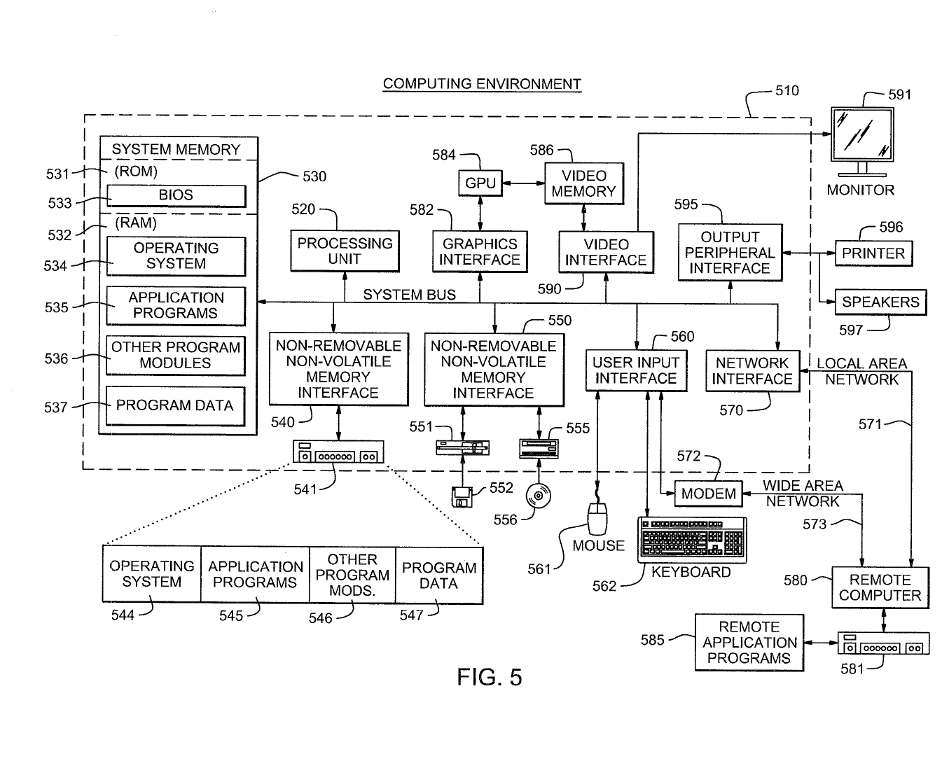

The method of the present invention will be generally implemented by a computer executing a sequence of program instructions for carrying out the steps of the method and may be embodied in a computer program product comprising media storing the program instructions. For example, FIG. 5 and the following discussion provide a brief general description of a suitable computing environment in which the invention may be implemented. It should be understood, however, that handheld, portable, and other computing devices of all kinds are contemplated for use in connection with the present invention. While a general-purpose computer is described below, this is but one example, the present invention may be implemented in an environment of networked hosted services in which very little or minimal client resources are implicated, e.g., a networked environment in which the client device serves merely as a browser or interface to the World Wide Web.

Although not required, the invention can be implemented via an application-programming interface (API), for use by a developer, and/or included within the network browsing software, which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations.

Other well known computing systems, environments, and/or configurations that may be suitable for use with the invention include, but are not limited to, personal computers (PCs), server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 5, thus, illustrates an example of a suitable computing system environment 500 in which the invention may be implemented, although as made clear above, the computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 600.

With reference to FIG. 5, an exemplary system for implementing the invention includes a general purpose-computing device in the form of a computer 510. Components of computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 510 typically includes a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 510.

Communication media typically embodies computer readable instructions, data structures, program modules or other data in a modulated data signal such as a carrier wave or other transport mechanism and includes any information delivery media. The temm “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 5 provide storage of computer readable instructions, data structures, program modules and other data for the computer 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies.

A user may enter commands and information into the computer 510 through input devices such as a keyboard 562 and pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus 621, but may be connected by other interface and bus structures, such as a parallel port, game port or a universal serial bus (USB).

A monitor 591 or other type of display device is also connected to the system bus 521 via an interface, such as a video interface 590. A graphics interface 582, such as Northbridge, may also be connected to the system bus 521. Northbridge is a chipset that communicates with the CPU, or host-processing unit 520, and assumes responsibility for accelerated graphics port (AGP) communications. One or more graphics processing units (GPUs) 584 may communicate with graphics interface 582. In this regard, GPUs 584 generally include on-chip memory storage, such as register storage and GPUs 584 communicate with a video memory 586. GPUs 584, however, are but one example of a coprocessor and thus a variety of co-processing devices may be included in computer 510. A monitor 591 or other type of display device is also connected to the system bus 521 via an interface, such as a video interface 590, which may in turn communicate with video memory 586. In addition to monitor 591, computers may also include other peripheral output devices such as speakers 597 and printer 596, which may be connected through an output peripheral interface 595.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 5 illustrates remote application programs 585 as residing on memory device 581. It will be appreciated that the network connections shown are exemplary and other means of establishing a communications link between the computers may be used.

One of ordinary skill in the art can appreciate that a computer 510 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of coding and filtering video data, comprising the steps of:
using a predictive coding technique to compress a stream of video data;
integrating a noise filtering process into said predictive coding technique; and
using said noise filtering process to noise filter said stream of video data of data while compressing said stream of video data.

2. A method according to claim 1, wherein said video stream is comprised of a series of macroblocks including a current macroblock and at least one reference macroblock, and wherein:
the step of using a predictive coding technique includes the step of calculating the difference between said current macroblock and said at least one reference macroblock; and
the step of integrating the noise filtering process includes the step of integrating the noise filtering process into said step of calculating.

3. A method according to claim 2, wherein the noise filtering process is a temporal noise filtering process.

4. A method according to claim 3, wherein said predictive coding technique is a forward predictive code mode.

5. A method according to claim 4, wherein the step of using said predictive coding technique includes the step of identifying a block as the best predictor of said current macroblock, and identifying a predictor error between said best predictor and said current macroblock.

6. A method according to claim 5, wherein the step of integrating the noise filtering into the predictive coding technique includes the step of scaling said predictor error to obtain a scaled predictor error.

7. A method according to claim 6, wherein the step of using said noise-filtering process includes the step of using said scaled predictor error to noise filter the video stream.

8. A method according to claim 3, wherein said predictive coding technique is a bi-directional predictor mode.

9. A method according to claim 8, wherein the step of using said predictive coding technique includes the step of identifying one previous macroblock and one future macroblock as the two best predictors of said current macroblock, and identifying a predictor error between said two best predictors and said current macroblock.

10. A method according to claim 2, wherein the step of using the predictive coding technique includes the steps of:
identifying a predictor between the current macroblock and the at least one reference macroblock; and
and adaptively scaling said predictor error.

11. An integrated system for coding and filtering a stream of video data, comprising:
a predictive coding subsystem to compress the stream of video data, said predictive coding subsystem having integrated therein a noise filtering process for noise filtering said stream of data.

12. An integrated system according to claim 11, wherein said stream of video data is comprised of a series of macroblocks, said series of macroblocks including a current macroblock and at least one reference macroblock, and wherein the predictive coding subsystem includes a unit for calculating the difference between said current macroblock and said at least one reference macroblock and for using said calculation for filtering noise from said current block.

13. An integrated system according to claim 12, wherein said unit is for calculating the difference between said current macroblock and one previous macroblock.

14. An integrated system according to claim 12, wherein said unit is for calculating the difference between said current macroblock and one previous macroblock and one future macroblock.

15. An integrated system according to claim 11, wherein the predictive coding subsystem calculates a scaled predictor error and uses said scaled predictor error both to compress the stream of video data and to filter noise from the video data.

16. An article of manufacture comprising:
at least one computer usable medium having computer readable program code logic to execute a machine instruction in a processing unit for coding and filtering video data, said computer readable program code logic, when executing, performing the following steps:
using a predictive coding technique to compress a stream of video data;
integrating a noise filtering process into said predictive coding technique; and
using said noise filtering process to noise filter said stream of video data while compressing said stream of video data.

17. An article of manufacture according to claim 16, wherein said stream of video data is comprised of a series of macroblocks, said series of macroblocks including a current macroblock and at least one reference macroblock, and wherein:
the step of using a predictive coding technique includes the step of calculating the difference between said current macroblock and said at least one reference macroblock; and
the step of integrating the noise filtering process includes the step of integrating the noise filtering process into said step of calculating.

18. An article of manufacture according to claim 17, wherein:
the noise filtering process is a temporal noise filtering process; and
said predictive coding technique is a forward predictive code mode, and includes the steps of identifying a block as the best predictor of said current macroblock, and identifying a predictor error between said best predictor and said current macroblock.

19. An article of manufacture according to claim 18, wherein the step of integrating the noise filtering into the predictive coding technique includes the steps of scaling said predictor error to obtain a scaled predictor error, and using said scaled predictor error to noise filter the video stream.

20. An article of manufacture according to 17, wherein:
said predictive coding technique is a bi-directional predictor mode, and includes the steps of identifying one previous macroblock and one future macroblock as the two best predictors of said current macroblock, and identifying a predictor error between said two best predictors and said current macroblock; and
the step of integrating the noise filtering into the predictive coding technique includes the steps of scaling said predictor error to obtain a scaled predictor error, and using said scaled predictor or to noise filter the video stream.
